(19) United States
(12) Patent Application Publication
(10) Pub. No.: US 2008/0012940 A1
(43) Pub. Date: Jan. 17, 2008

(54) Vehicle image display system and image display method

(75) Inventors: Akihiro Kanaoka, Hadano-shi (JP); Makoto Kimura, Sagamihara-shi (JP); Kazuhiko Sakai, Fujisawa-shi (JP); Daisuke Sugawara, Isehara-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/822,352

(22) Filed: Jul. 5, 2007

(30) Foreign Application Priority Data
Jul. 6, 2006 (JP) 2006-186719
Jun. 15, 2007 (JP) 2007-158647

(51) Int. Cl. H04N 7/18; B60Q 1/00

(52) U.S. Cl. 348/148; 340/435

(57) ABSTRACT

When an image processing device subjects images photographed by on-vehicle cameras to viewpoint changing, and joints the images to form a top view image, and superposes masks on joints of the top view image to display it as an image to be monitored in a display, the masks of the top view image are highlighted until a passage of predetermined time after predetermined conditions are established. Thus, the masks can be made conspicuous only when necessary to be presented to an occupant of a vehicle, and an easily seen top view image can be displayed while preventing a reduction in effectiveness of warning of the masks.

### BACKGROUND OF THE INVENTION

The present invention relates to an vehicle image display system and an image display method for joining a plurality of images photographed by a plurality of on-vehicle cameras to form a composite image, and then to display the composite image in a display device in a car room.

A technology has conventionally been in widespread use, which joins a plurality of images photographed by a plurality of on-vehicle cameras to form a composite image, and displays the composite image in a display device in a car room to assist driver's field of vision, thereby enhancing safety of vehicle driving. In many cases, the composite image formed by joining the plurality of images does not accurately reflect an actual landscape because of a loss of continuity of images at the joints. Under these circumstances, as disclosed in Japanese Patent Application Laid-Open No. 2003-67735, inaccuracy of images at the joints is indicated by masking the joints of the images, thereby giving a warning to occupants of the vehicle.

### SUMMARY OF THE INVENTION

According to the conventional technology, however, masks have always been superposed on the joints of the composite image in a certain display form. Thus, for example, when the occupants of the vehicle get used to this display, the masks lose visibility, creating a possibility of a reduction in effectiveness of warning.

The present invention has been developed to solve the aforementioned problem of the conventional technology, and it is an object of the invention to provide a vehicle image display system and an image display method which can display a composite image to be easily seen while preventing a reduction in effectiveness of mask warning.

According to the present invention, the vehicle image display system and the image display method solves the problem by highlighting masks of a composite image until a passage of predetermined time after predetermined conditions are established when a plurality of images photographed by a plurality of on-vehicle cameras are jointed to form a composite image, and masks are superposed on the composite image to cover joints of the plurality of images, and displayed.

### BRIEF DESCRIPTION OF THE DRAWINGS

FIG. 1 is a block diagram showing a configuration of a vehicle image display system according to the present invention.

FIG. 2 is a diagram showing a specific example of installing positions and photographing areas of four on-vehicle cameras.

FIG. 3 is a diagram showing a top view image formed by changing viewpoints and joining images photographed by the four on-vehicle cameras installed around a vehicle.

FIGS. 4A to 4C are diagrams showing a viewpoint changing process executed by an image synthesis unit of an image processing device: FIG. 4A showing a relation of positions and photographing areas between a real camera and a virtual camera, FIG. 4B showing an image of a photographing area photographed by the real camera (image before viewpoint changing), and FIG. 4C showing an image of a photographing area photographed by the virtual camera (image after viewpoint changing).

FIG. 5 is a diagram showing a situation in which masks are superposed to cover image joints of the top view image.

FIG. 6 is a diagram showing an example of a screen configuration of an image displayed in a display.

FIG. 7 is a flowchart showing a specific example of a process regarding mask display control executed by the image processing device after an ignition switch of the vehicle is turned ON in the vehicle image display system of the embodiment.

### DETAILED DESCRIPTION OF THE PREFERRED EMBODIMENTS

A specific example of a vehicle image display system capable of displaying a composite image looking down at all the surroundings of a vehicle from a virtual viewpoint above the vehicle according to an embodiment of the present invention will be described below. The vehicle image display system of the invention includes a function of photographing images of four directions around the vehicle by four on-vehicle cameras of the vehicle, and displaying a plurality of images as images to be monitored in a display of a car room while switching the images according to an operation of a vehicle occupant. The vehicle image display system includes a function of changing viewpoints of original images photographed by the on-vehicle cameras into overview images and joining the images to form a composite image looking down at all the surroundings of the vehicle from a virtual viewpoint above the vehicle, and combining the composite image with one of the original images photographed by the on-vehicle cameras and before viewpoint changing to be displayed as an image to be monitored in the display of the car room.

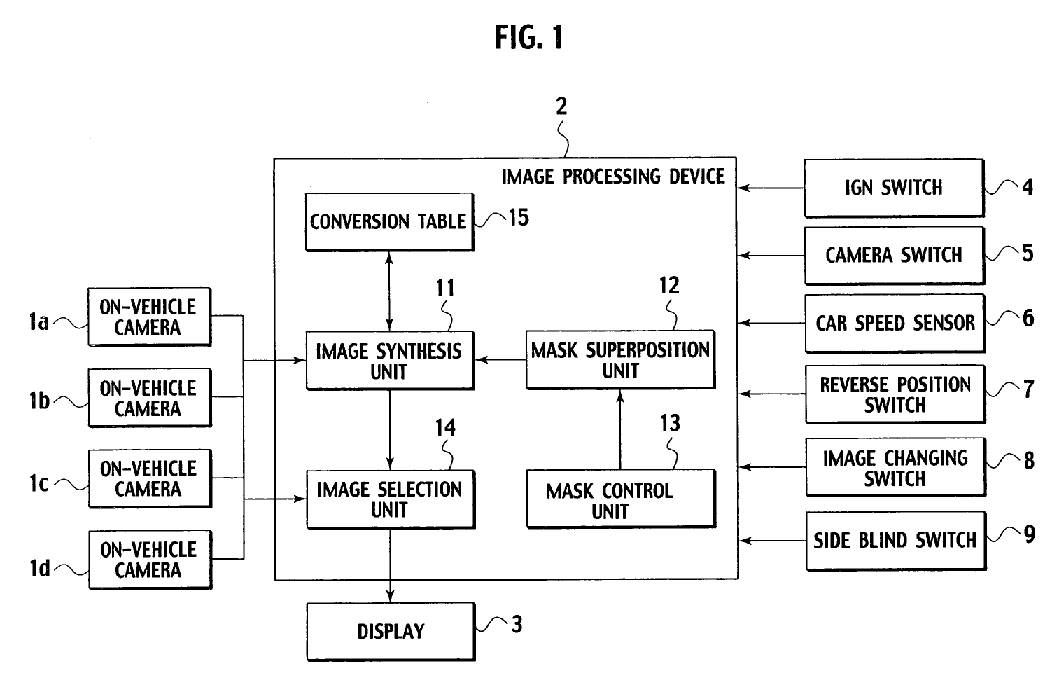

FIG. 1 shows a configuration of the vehicle image display system of the invention. This vehicle image display system includes four on-vehicle cameras 1a to 1d, an image processing device 2, and a display 3 in a car room as main components. An ignition switch 4, a camera switch 5, a car speed sensor 6, a reverse position switch 7, an image changing switch 8, and a side blind switch 9 are connected to the image processing device 2.

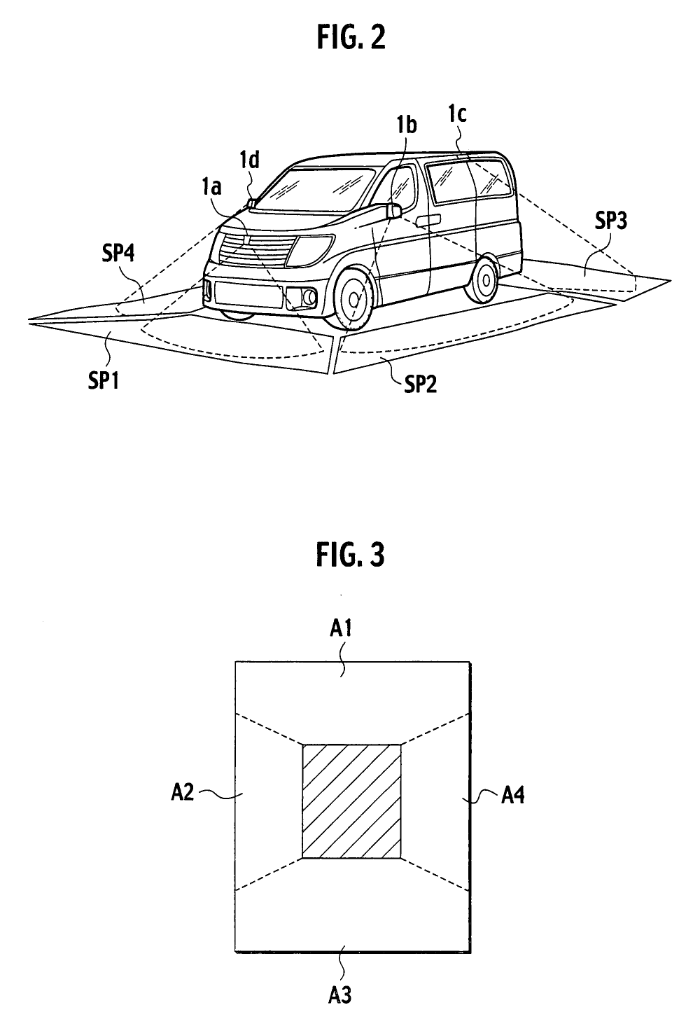

The on-vehicle cameras 1a to 1d are installed in the front, rear, left and right sides of the vehicle to photograph images of four directions around the vehicle. For example, as shown in FIG. 2, the on-vehicle camera 1a is installed in a predetermined position of the front side of the vehicle such as a position near a front grille to photograph an image (front view image hereinafter) of a predetermined photographing area SP1 of the front side of the vehicle. The on-vehicle camera 1b is installed in a predetermined position of the left side of the vehicle such as a left side mirror to photograph an image (left side view image) of a predetermined photographing area SP2 of the left side of the vehicle. The on-vehicle camera 1c is installed in a predetermined area of the rear side of the vehicle such as a roof spoiler to photograph an image (rear view image) of a predetermined photographing area SP3 of the rear side of the vehicle. The on-vehicle camera 1d is installed in a predetermined position of the right side of the vehicle such as a right side mirror to photograph an image (right side view image) of a predetermined photographing area SP4 of the right side of the vehicle. Data of the images photographed by the four on-vehicle cameras 1a to 1d are fed to the image processing device 2 as needed.

The image processing device 2 includes an image synthesis unit 11 for forming a composite image (top view image hereinafter) looking down at all the surroundings of the vehicle from a virtual viewpoint above the vehicle, a mask superposition unit 12 for superposing a mask on the top view image formed by the image synthesis unit 11, a mask control unit 13 for controlling a display form of the mask superposed by the mask superposition unit 12, and an image selection unit 14 for selecting an image to be displayed as an image to be monitored in the display 3.

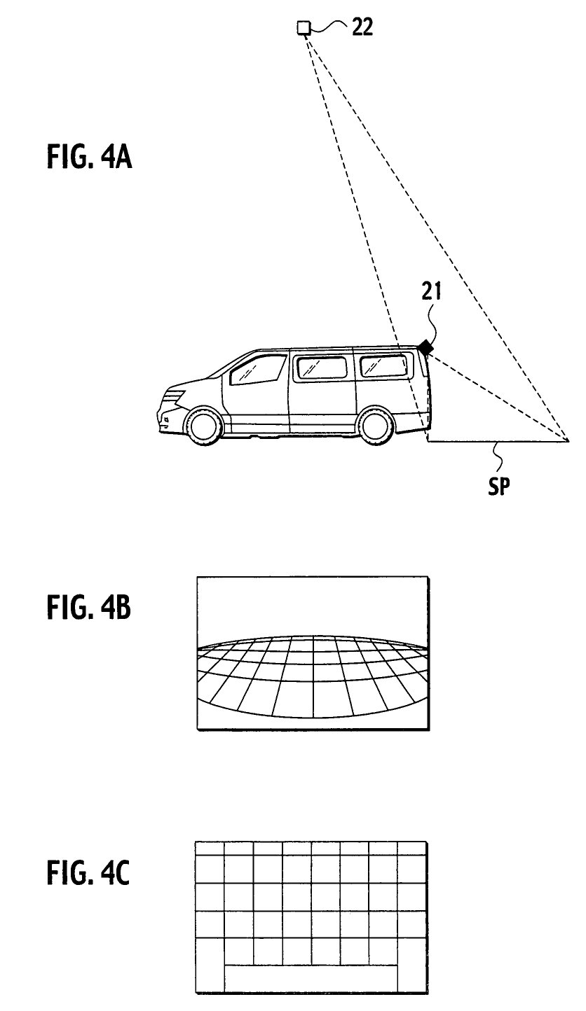

The image synthesis unit 11 viewpoint-changes the front view image, the left side view image, the rear view image, and the right side view image photographed by the on-vehicle cameras 1a to 1d into overview images by using a conversion table 15 describing a correspondence of image addresses between images before and after conversion, and joins these images to form a top view image similar to that shown in FIG. 3. The viewpoint changing process of the image synthesis unit 11 means a process of converting an image similar to that shown in FIG. 4B which is obtained by, for example, photographing a predetermined photographing area SP with an installing position of a real camera 21 of FIG. 4A set as a viewpoint into an overview image (image looking down at a photographing area directly above the vehicle center) similar to that shown in FIG. 4C when a predetermined photographing area SP is photographed by using a virtual camera 22 of FIG. 4A as a viewpoint. A relation between the images before and after conversion is uniquely decided based on lens characteristics of the on-vehicle camera and a mounting angle. Thus, the viewpoint changing process of the image synthesis unit 11 can be realized only by coordinate conversion of an image memory using the conversion table 15. The image synthesis unit 11 carries out the viewpoint changing process for the front view image, the left side view image, the rear view image, and the right side view image photographed by the on-vehicle cameras 1a to 1d, cuts out necessary parts of obtained overview images and joins the images to form a top view image similar to that shown in FIG. 3.

In an image example of FIG. 3, an image area A1 is a cutout of a part of the overview image obtained by subjecting the front view image photographed by the on-vehicle camera 1a to viewpoint changing, an image area A2 is a cutout of a part of the overview image obtained by subjecting the left side view image photographed by the on-vehicle camera 1b to viewpoint changing, an image area A3 is a cutout of a part of the overview image obtained by subjecting the rear view image photographed by subjecting the rear view image photographed by the on-vehicle camera 1c to viewpoint changing, and an image area A4 is a cutout of a part of the overview image obtained by subjecting the right side view image photographed by the on-vehicle camera 1d to viewpoint changing. In the image example of FIG. 3, a shaded area of the image center indicates a position of the vehicle.

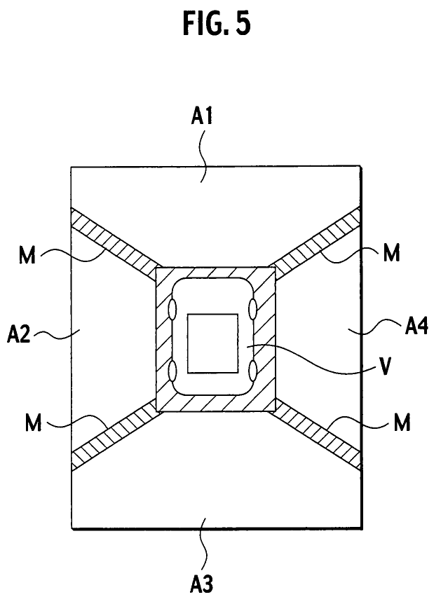

The mask superposition unit 12 superposes masks M on the top view image to cover joints of the adjacent image areas A1 to A4 of the top view image formed by the image synthesis unit 11 under control of the mask control unit 13. The top view image formed by the image synthesis unit 11 is an image formed by joining the overview images by the viewpoint changing process as described above. Thus, image distortion caused by an influence of the viewpoint changing concentrates on the joints of the image areas A1 to A4 which are joints of the overview images, causing a loss of image continuity. Especially, when a solid object of a road appears in the joints of the image areas A1 to A4 of the top view image, recognition of the solid object is difficult because of image discontinuity. Accordingly, for example, as shown in FIG. 5, the mask superposition unit 12 superposes masks M on the joints of the adjacent image areas A1 to A4 of the top view image formed by the image synthesis unit 11, thereby enabling an occupant of the vehicle to recognize presence of joints which causes a lack of accuracy of the image. In the image example of FIG. 5, the vehicle V of the image center is a computer graphics (CG) image superposed on the top view image to enable the vehicle occupant to understand a position of the vehicle.

As described above, the masks M are superposed on the top view image to cover the joints, and inaccuracy of the image of these parts is presented to the occupant of the vehicle to give a warning. However, if the masks M always superposed in a fixed display form, for example, when the occupant of the vehicle gets used to this display, there is a possibility that the masks M will lose visibility to cause a reduction in effectiveness of the warning.

Thus, the vehicle image display system of the present invention includes the mask control unit 13 disposed in the image processing device 2. This mask control unit 13 enables proper changing of the display form of the masks M superposed on the top view image. Especially, the mask control unit 13 controls the display form of the masks M so that the masks M of the top view image can be highlighted only until a passage of predetermined time after predetermined conditions are established. The predetermined conditions are conditions for specifying situations which need warning by the masks M to the occupant of the vehicle, for example, a case in which after the ignition switch 4 is turned ON, the top view image is first displayed in the display 3 according to an operation of the camera switch 5. As conditions, in addition to the case in which the top view image is first displayed after the ignition switch is turned ON, various conditions can be set according to experience or market demands. The predetermined time is set to sufficiently direct attention of the occupant of the vehicle to the masks M of the top view image, for example, 7 seconds.

An example of highlighting of the masks M is changing of a display color of the masks M. In other words, the masks M are displayed by a conspicuous color such as yellow to give a warning only until a passage of predetermined time after predetermined conditions are established, and then displayed by a relatively inconspicuous color such as black. Even in the case of the same color, it is effective to highlight the masks M by displaying the masks M by a first luminance only until the passage of predetermined time after the predetermined conditions are established, and then to display the masks M by a second luminance lower than the first luminance. Even in the case of the same color, it is effective to highlight the masks M by flashing the masks M only until the passage of predetermined time after the predetermined conditions are established, and then to continue displaying of the masks M. Further, if the masks M are flashed by a conspicuous color such as yellow to be displayed until the passage of predetermined time after the predetermined conditions are established, and then the masks M are continuously displayed by a relatively inconspicuous color such as black, effectiveness of warning can be enhanced more.

The control of the highlighting of the masks M by the mask control unit 13 may be executed by using setting in which control of the highlighting is valid as a condition according to a switch operation of the occupant of the vehicle. Accordingly, the occupant of the vehicle can select whether to execute highlighting control of the masks M, solving a problem that the occupant of the vehicle feels irritated because of execution of unnecessary control.

In the highlighting control of the masks M, the masks M are changed from a highlighted state to a normal display state after the passage of predetermined time after the predetermined conditions are established. This display change of the masks M is preferably executed slowly, taking predetermined time, for example, 2 seconds. Thus, uncomfortable feelings caused by an extreme change of the display form of the masks M can be reduced.

As described above, the mask control unit 13 basically controls the highlighting of the masks M to prevent a reduction in effectiveness of warning to the occupant of the vehicle. Additionally, a display form in which a display color or a luminance of the masks M is changed according to an environmental change such as brightness in the car room can be controlled. Specifically, for example, control may be executed in such a manner that the masks M are displayed black in the daytime, and displayed white or flashed black and white at night by using an ON/OFF signal of the vehicle lighting or a signal from an automatic light sensor. Accordingly, by executing control to optimally change the display form of the masks M according to an environmental change, it is possible to effectively curtail a reduction in visibility of the masks M of the top view image.

According to various signals input from a car speed sensor 6, a reverse position switch 7, an image changing switch 8, and a side blind switch 9, the image selection unit 14 selects an image to be displayed as an image to be monitored in the display 3 among the front view image photographed by the on-vehicle camera 1a, the left side view image photographed by the on-vehicle camera 1b, the rear view image photographed by the on-vehicle camera 1c, the right side view image photographed by the on-vehicle camera 1d, and the top view image formed by the image synthesis unit 11 and having the masks M superposed thereon by the mask superposition unit 12.

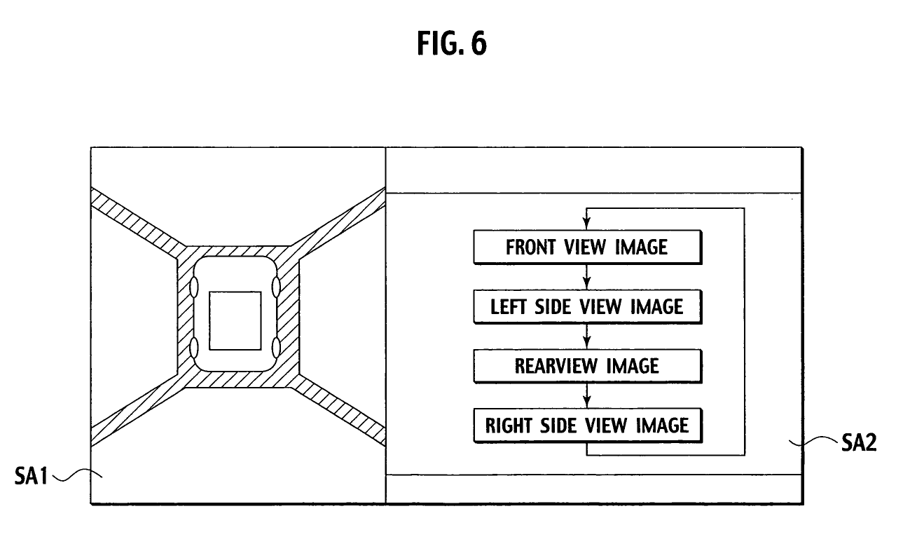

FIG. 6 shows a screen configuration example of an image displayed in the display 3 to be monitored. In the example of FIG. 6, for the image displayed in the display 3 to be monitored, an entire screen is divided into two left and right sides. A top view image can be displayed in a display area SA1 of the screen left side, and any one of a front view image, a left side view image, a rear view image, and a right side view image can be displayed in a display area SA2 of the screen right side.

In the case of the screen configuration example of the image to be monitored shown in FIG. 6, upon recognition that the image to be monitored is displayed in the display 3 by an operation of the camera switch 5, the image selection unit 14 first selects a top view image having masks M superposed thereon as an image to be displayed in the display area SA1 of the screen left side, and a front view image as an image to be displayed in the display area SA2 of the screen right side. Then, when the occupant of the vehicle operates the screen changing switch 8, the image selection unit 14 switches images to be displayed in the display area SA2 of the screen right side in an order of a front view image→right side view image→rear view image→left side view image→the front view image . . . . Upon reception of a reverse signal indicating setting of a shift position to reverse from the reverse position switch 7, the image selection unit 14 switches the image to be displayed in the display area SA2 of the screen right side to the rear view image irrespective of the aforementioned switching order.

When the occupant of the vehicle operates the side blind switch 9, the image selection unit 14 switches the image to be displayed in the display area SA1 of the screen left side from the top view image to the right side view image. Then, when the side blind switch 9 is operated again, the image to be displayed in the display area SA1 of the screen left side is switched from the right side view image to the top view image. The displaying of the image to be monitored is carried out under the condition that a traveling speed of the vehicle is less than a predetermined value. When the traveling speed of the vehicle is determined to be equal to or more than the predetermined value based on a signal from the car speed sensor 6, the image to be displayed in the display 3 is switched from the image to be monitored to an original image, i.e., a navigation image or a television image displayed in the display 3 before the camera switch 5 is operated to start displaying of the image to be monitored.

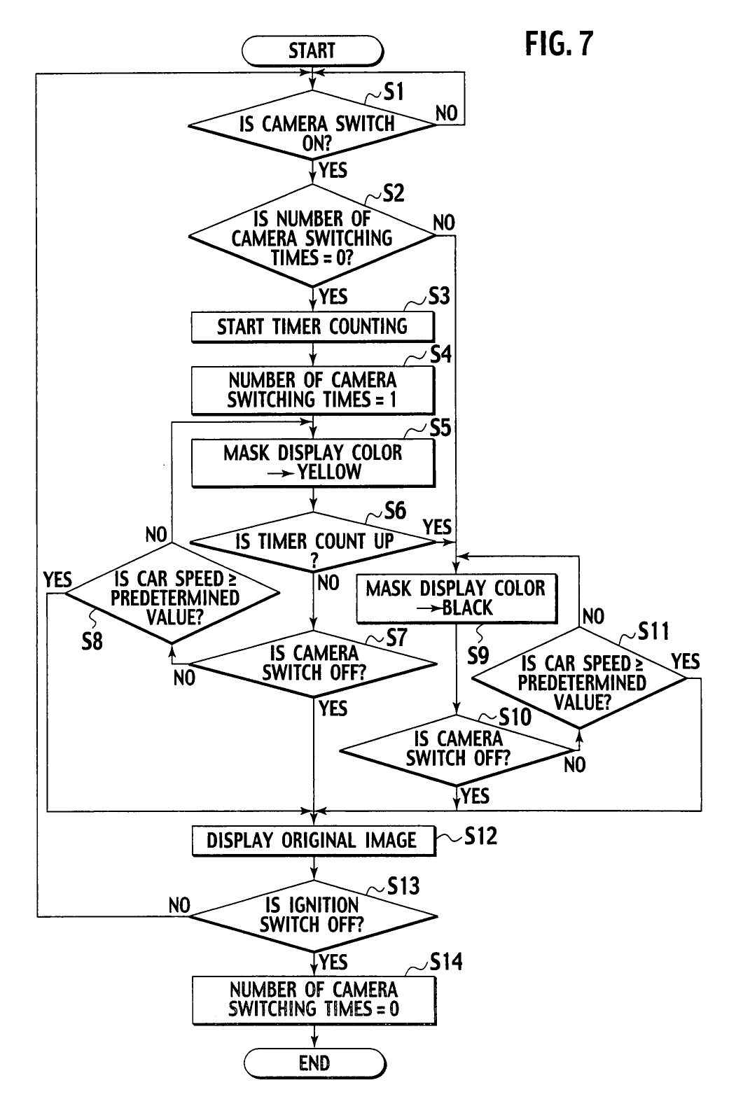

Next, referring to a flowchart of FIG. 7, an operation of the vehicle image display system of the embodiment configured in the aforementioned manner will be described focusing on the display control of the masks M which is a feature of the present invention. The flowchart of FIG. 7 shows a specific example of a process of the display control of the masks M executed by the image processing device 2 after the vehicle ignition switch 4 is turned ON in the vehicle image display system of the embodiment. According to this example, it is presumed that a top view image is displayed for the first time after the ignition switch 4 is turned ON, masks M of a top view image are highlighted as a condition, and a highlighting method displays the masks M by yellow. In the image processing device 2, a process of fetching a front view image, a left side view image, a rear view image, and a right side view image photographed by the on-vehicle cameras 1a to 1d to save the images, and forming a top view image from these images is executed in parallel with the process shown in FIG. 7.

Upon turning-ON of the vehicle ignition switch 4, the image processing device 2 first monitors an ON-operation of the camera switch 5 in step S1. When the occupant of the vehicle turns the camera switch 50N to input an ON-signal therefrom, the image processing device 2 checks whether the number of camera switching times is 0 in step S2. The number of camera switching times indicates the number of turning ON the camera switch 5 while the ignition switch 4 is ON. An initial value is 0, and incremented each time the camera switch 5 is turned ON. Accordingly, when the camera switch 5 is turned ON for the first time after the ignition switch 4 is turned ON, the number of camera switching times is 0.

The image processing device 2 displays an image to be displayed which contains the top view image in the display 3 according to the ON-operation of the camera switch 5. In this case, if a result of the determination in the step S2 shows the number of camera switching times=0, in next step S3, timer counting for counting predetermined time (e.g., 7 seconds) is started. In step S4, the number of camera switching times is incremented to 1. Then, in step S5, yellow is selected as a display color of the masks M of the top view image, and the top view image having the yellow masks M superposed thereon to cover joints of the images is displayed as an image to be monitored in the display 3.

The highlight-displaying of the top view image by using yellow as the display color of the masks M is continued until the timer counting started in the step S3 is counted up as long as the camera switch 5 is ON and the vehicle traveling speed is less than the predetermined value. Upon determination of counting-up of the timer counting in step S6, the process proceeds to step 9 to switch the display color of the masks M of the top view image from yellow to black.

If an OFF-operation of the camera switch 5 is detected before the timer counting started in the step S3 is counted up in step S7, the process proceeds to step S12 to switch the image displayed in the display 3 from the image to be monitored to an original image such as a navigation image or a television image. If the vehicle traveling speed is determined to be equal to or more than the predetermined value based on a signal from the car speed sensor 6 before the timer counting started in the step S3 is counted up in step S8, the process proceeds to the step S12 to switch the image displayed in the display 3 from the image to be monitored to the original image.

When ON and OFF operations of the camera switch 5 is repeated by a plurality of times while the ignition switch 4 is ON, the image processing device 2 displays the image to be monitored which contains the top view image in the display 3 each time the camera switch 5 is turned ON. In this case, as the number of camera switching times is a value other than 0, the determination result of the step S2 is NO. In this case, in step S9, the image processing device 2 selects black as a display color of the masks M of the top view image, and displays the top view image having the black masks M superposed thereon to cover the joints of the images as an image to be monitored in the display 3. The displaying of the image to be monitored is continued as long as the camera switch 5 is ON and the vehicle traveling speed is less than the predetermined value. If an OFF-operation of the camera switch 5 is detected in step S10, or if the vehicle traveling speed is determined to be equal to or more than the predetermined value based on a signal from the car speed sensor 6 in step S11, the process proceeds to the step S12 to switch the image displayed in the display 3 from the image to be monitored to the original image.

Subsequently, in step S13, the image processing device 2 monitors switching of the vehicle ignition switch 4 from ON to OFF. The process of the step S1 and after is repeated if the ignition switch 4 is ON. Upon switching of the ignition switch 4 to OFF, in step S14, the number of camera switching times is reset to 0, and the series of operations is finished.

As described above by taking the specific examples, according to the vehicle image display system of the embodiment, when the image processing device 2 subjects the images photographed by the on-vehicle cameras 1a to 1d to viewpoint changing, and joints the images to form a top view image, and superposes the masks M on the joints of the top view image to display the image as the monitor displayed in the display 3 to be monitored, for example, the masks M of the top view image are highlighted until the passage of predetermined time after the predetermined conditions such as first top view image displaying time after the ignition switch is turned ON are established. Thus, the masks M can be made conspicuous especially in a situation in which a warning should be given to the occupant of the vehicle by the masks M, and the easily seen top view image can be displayed as an image to monitored in the display 3 while preventing a reduction in effectiveness of the warning by the masks M.

The entire contents of a Japanese Patent Application No. P2006-186719 with a filing date of Jul. 6, 2006 and a Japanese Patent Application No. P2007-158647 with a filing date of Jun. 15, 2007 in Japan are herein incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A vehicle image display system comprising:
a plurality of on-vehicle cameras configured to photograph surroundings of a vehicle;
an image synthesis unit configured to join a plurality of images photographed by the plurality of on-vehicle cameras to form a composite image;
a mask superposition unit configured to superpose masks on the composite image to cover joints of the plurality of images;
a display unit configured to display the composite image having the masks superposed thereon; and
a mask control unit configured to highlight the masks of the composite image until a passage of predetermined time after predetermined conditions are established.

2. The vehicle image display system according to claim 1, wherein the mask control unit highlights the masks by flashing the masks of the composite image until the passage of predetermined time after the predetermined conditions are established, and continues the displaying of the masks after the passage of predetermined time.

3. The vehicle image display system according to claim 1, wherein the mask control unit highlights the masks by displaying the masks of the composite image by a first display color until the passage of predetermined time after the predetermined conditions are established, and displays the masks by a second display color after the passage of predetermined time.

4. The vehicle image display system according to claim 3, wherein the first display color is yellow, and the second display color is black.

5. The vehicle image display system according to claim 2, wherein the mask control unit highlights the masks by flashing the masks of the composite image by a first display color until the passage of predetermined time after the predetermined conditions are established, and continues the displaying of the masks by a second display color after the passage of predetermined time.

6. The vehicle image display system according to claim 5, wherein the first display color is yellow, and the second display color is black.

7. The vehicle image display system according to claim 1, wherein the mask control unit highlights the masks by displaying the masks of the composite image by a first luminance until the passage of predetermined time after the predetermined conditions are established, and displays the masks by a second luminance after the passage of predetermined time.

8. The vehicle image display system according to claim 1, wherein the mask control unit highlights the masks of the composite image until the passage of predetermined time when the composite image is first displayed after an ignition switch of the vehicle is turned ON.

9. A vehicle image display system comprising:
a plurality of on-vehicle cameras configured to photograph surroundings of a vehicle;
an image synthesis unit configured to join a plurality of images photographed by the plurality of on-vehicle cameras to form a composite image;
a mask superposition unit configured to superpose masks on the composite image to cover joints of the plurality of images;
a display unit configured to display the composite image having the masks superposed thereon; and
a mask control unit configured to continuously display the masks of the composite image by yellow until a passage of predetermined time when the composition image is first displayed after an ignition switch of the vehicle is turned ON, and continuously display the masks by black after the passage of predetermined time.

10. A vehicle image display system comprising:
photographic means for photographing surroundings of a vehicle;
means for joining a plurality of images photographed by the photographic means to form a composite image;
means for superposing masks on the composite image to cover joints of the plurality of images;
means for displaying the composite image having the masks superposed thereon; and
means for highlighting the masks of the composite image until a passage of predetermined time after predetermined conditions are established.

11. An image display method for joining a plurality of images around a vehicle photographed by a plurality of on-vehicle cameras to form a composite image, superposing masks on the composite image to cover joints of the plurality of images, and displaying the composite image in a display unit, comprising the process of:
carrying out mask display control for highlighting the masks of the composite image until a passage of predetermined time after predetermined conditions are established.
